(19) United States
(12) Patent Application Publication
(10) Pub. No.: US 2008/0048071 A1
(43) Pub. Date: Feb. 28, 2008

(54) Neon tube support saddle with mating tube restraint

(75) Inventors: Mark Levi Luehne, Galesville, WI (US); Keith Edward LeMere, Galesville, WI (US)

Correspondence Address: Richard S Missimer, PO Box 486, Butler, WI, 53007-0486, US

(73) Assignee: Everbrite, L.L.C.

(21) Appl. No.: 11/509,848

(22) Filed: Aug. 25, 2006

(51) Int. Cl. F16L 3/00

(52) U.S. Cl. 248/50

(57) ABSTRACT

This invention is geared towards the manufacturing and secure shipment of neon signage, which has historically used restraining devices that restrict the view of the neon tube after the sign has been installed. This invention uses clear plastic and mating locking devices to create a new neon tube support saddle with mating tube restraint that holds the neon tube securely in place, yet does not restrict the view of the neon light. Such restraint provides a shippable sign that requires no additional handling. The resulting fast and simple sign installation saves both the manufacturer and the installer time and money, and eliminates the need for repetitive movements that cause stress injuries, such as carpal tunnel syndrome.

### FIELD OF THE INVENTION

This invention relates to neon signs, specifically it is an improved neon tube support saddle and mating tube restraint for securing neon tubes. Neon is used herein as the generic term for light emitting inert gases, such as, neon, mercury vapor, xenon and helium, argon and krypton.

### DISCUSSION OF THE RELATED ART

Neon signs customarily consist of frames or panels upon which pre-shaped, gas-filled, glass tubes (“neon tubes”) are attached. During shipping, neon tubes are secured to neon signs by neon tube support saddles. Neon tube support saddles are designed to hold neon tubes in a fixed position and absorb shock. Thus, when a neon sign experiences a distorting or vibrational force during shipping, the neon tube support saddles allow the neon tubes to be somewhat isolated from the sign frame, thereby substantially reducing the likelihood of the tubes being broken.

Various neon tube support saddles have been used to secure neon tubes during shipping. These saddles, however, have only provided partial solutions to the problems associated with securing neon tubes. For example, U.S. Pat. No. 2,352,318 to Guarnaschelli (1944) and U.S. Pat. No. 2,545,416 to Staff (1951) shape a single piece of wire into a saddle. Such “wire saddles” require intense labor to produce; for, they must be wired to the sign's shape. This intense labor results in high production costs and causes laborers to sustain repetitive motion injuries, such as, carpal tunnel syndrome. Moreover, such wire saddles are visible and unsightly when the sign is lit. Thus, they are sometimes removed when the sign reaches its destination.

U.S. Pat. No. 4,666,109 to Fallon, et al. (1987) encompasses a pincher-like neon tube support saddle; while U.S. Pat. No. 5,257,762 to Trame, et al. (1993); and U.S. Pat. No. 5,464,178 to Grinwald, et al. (1994); have horseshoe-shaped neon tube support saddles. In all three of these patents, the saddles create openings smaller than a neon tube. Thus to contain tubes, these saddles rely on the pressure that their sides put on the tubes. If these saddles were hit with a sufficient amount of force, the tubes would be jostled out and more susceptible to fracturing and/or breakage. Like wire saddles, neon tube support saddles made from opaque materials would be visible and unsightly when the sign was lit.

### BACKGROUND OF THE INVENTION

This invention is an improved neon tube support saddle with mating tube restraint. In their preferred embodiment, the saddle and restraint are made from a polymeric or similar material that allows light to pass through. Hence, they do not need to be tailored to a specific sign and are cost-effective to produce. Moreover, neither the saddle, nor the restraint will interfere with a lit neon sign's aesthetics.

Because the saddle and restraint element (or cap) do not need to be removed when the sign is lit, the sign is shipped in the exact state it will be used. Further, the saddle and restraint can continue to protect the neon tubes from being broken while the sign is on display.

This invention is more likely to keep neon tubes from being broken than the prior art, due to the mating tube restraint. To keep the tubes from being broken, the prior art relied solely on the pressure created by the neon tube support saddle's sides. A sufficient amount of force would cause a tube to slip out of such a saddle. Here, the restraint would contain the tube under such force.

This invention may be used in conjunction with the cylindrical bodies referred to in U.S. Pat. No. 5,257,762 to Trame, et al. (1993) and U.S. Pat. No. 5,464,178 to Grinwald, et al. (1994), or any similar device.

Further objects and advantages of the invention will become apparent from a consideration of the drawings and ensuing description.

### BRIEF SUMMARY OF THE INVENTION

This invention has three major elements: (1) a stem member, (2) a neon tube support saddle (with engaging clip), and (3) a restraining element. In their preferred embodiment, all three of these elements would be made from a polymeric or similar material that allows light to pass through. Thus, neither the neon tube support saddle's engaging clip, nor the restraining element would interfere with a lit neon sign's aesthetics.

The stem member would allow the invention to lock into a cylindrical body such as the one referred to in U.S. Pat. No. 5,257,762 to Trame, et al. (1993), or U.S. Pat. No. 5,464,178 to Grinwald, et al. (1994), or any similar device.

The neon tube support saddle, engaging clip and the restraining element must interlock. Therefore, either the neon tube support saddle with engaging clip incorporates at least one male locking device, and the restraining element incorporates at least one female locking device;—or—the neon tube support saddle with engaging clip incorporates at least one female locking device, and the restraining element incorporates at least one male locking device. Hence, this invention is better at restraining neon tubes than the prior art, which relied solely on the pressure created by the neon tube support saddle's engaging clip sides.

### BRIEF DESCRIPTION OF THE DRAWINGS

FIG. 1. is a perspective view of the new neon tube support stem;

FIG. 2. is a front view with cut away of the cylinder

FIG. 3. is a front view of the neon tube support stem with restraining element attached

FIG. 4. is a back view of the neon tube support stem without the restraining element

FIG. 5. is a right side view of the neon tube support stem with restraining element attached

FIG. 6. is a left side view of the neon tube support stem with restraining element attached

FIG. 7. is the top view of the neon tube support stem with restraining element attached

FIG. 8. is the bottom view of the neon tube support stem with restraining element attached

### DRAWINGS—REFERENCE NUMERALS

100—stem member
101—stem lower cylindrical portion
102—stem upper cylindrical portion
103—locking knob
104—helical spring
105—neon tube support saddle and engaging clip
106—engaging clip vertical leg
107—female locking device
108—neon tube
109—restraining element
110—male locking device

### DESCRIPTION OF A PREFERRED EMBODIMENT

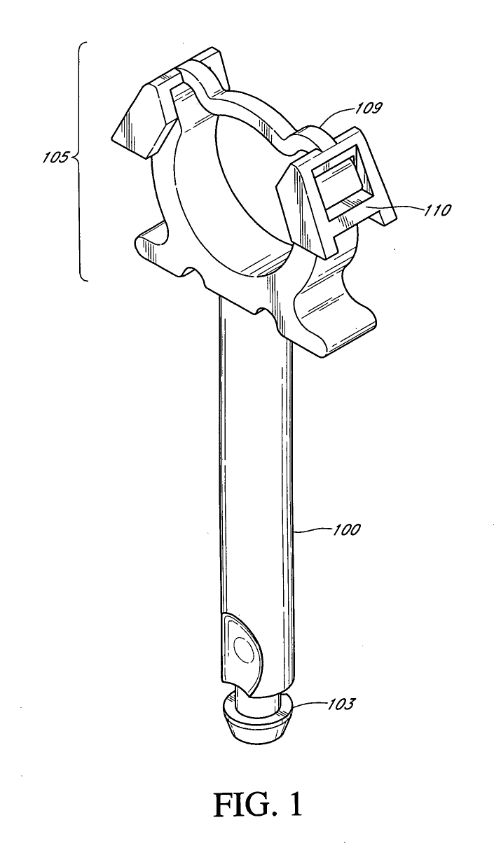

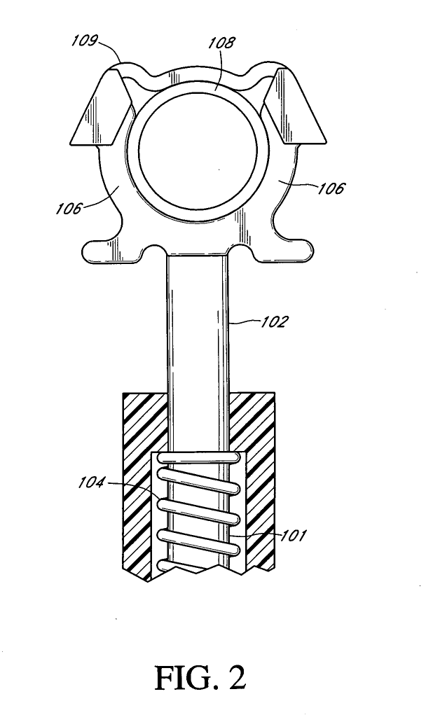

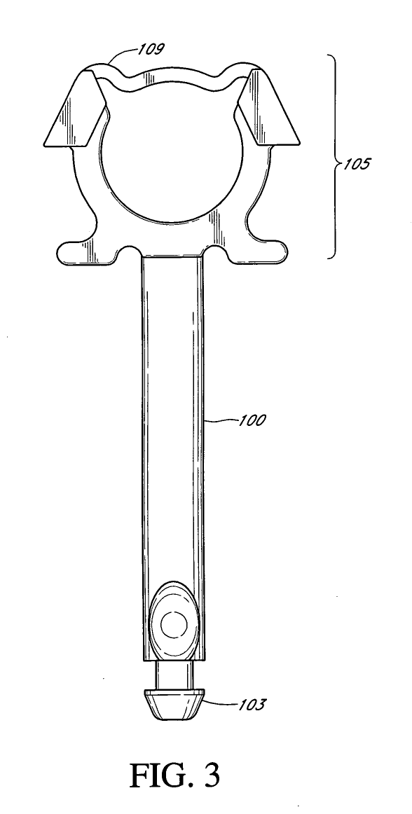

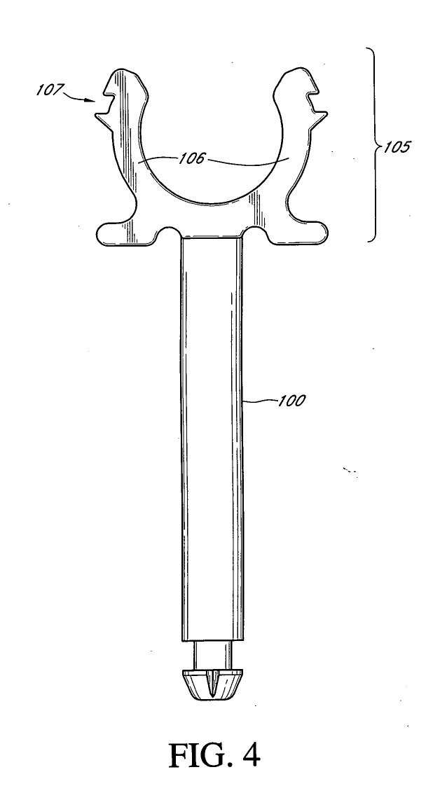

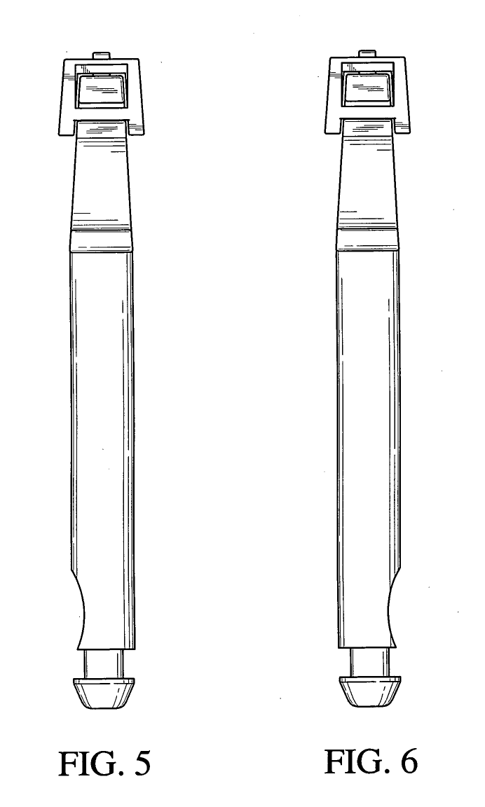

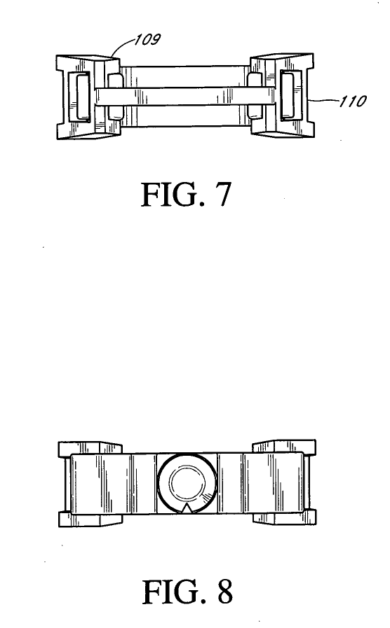

The neon tube support stem member depicted in FIG. 1 includes a stem member 100 that terminates in a neon tube support saddle and engaging clip 105 (see FIG. 3). The stem member 100 is preferably composed of a tough plastic, such as, polycarbonate resin. The FIG. 2 frontal view shows that the stem member 100 comprises a stem upper cylindrical portion 102, which is the portion of the stem member shaft that is outside of the cylinder, and a stem lower cylindrical portion 101, which is inside of the cylinder. The stem lower cylinder portion 101 terminates in a locking knob 103 that holds the stem lower cylinder portion 101 within the cylinder by being trapped within the helical spring 104. The stem upper cylinder portion 102 terminates in a neon tube support saddle (and engaging clip 105) that holds the neon tube 108. The neon tube saddle and engaging clip 105 has two vertical legs 106, each of which end with a female locking device 107 (see FIG. 4). The restraining element 109 has two male locking devices 110 (see FIG. 7), one at each end of this clear plastic restraining element 109. These male locking devices 110 are the mating devices for the female locking devices 107 at the outside end of the two vertical legs 106.

To install the neon tube 108 within the sign, the installer places and attaches, by screw or other fastener, the cylindrical base to the rigid sign media. The two vertical legs 106 are flexed outward slightly as the neon tube 108 is snapped into place between the two vertical legs 106. After the tube is installed, these two vertical legs 106 are pulled tightly against the neon tube 108 by means of the restraining element 109 that is locked into place. This restraining element 109 has the male locking portion 110 (see FIG. 1) that mates with the female locking 107 (see FIG. 4) of the vertical legs 106.

The neon tube support saddle and engaging clip 105 is thereby capped with a neon tube restraining element 109, which, in its preferred embodiment, is removable, plastic, and clear.

Alternatively, the restraining element 109 could be as simple as a wire, a rubber band, a tie wrap, or the neon tube saddle and engaging clip 105 could be fashioned in such a way as to integrate the restraining element 109, thereby eliminating the need for a separate restraining element while retaining the same desired functionality.

Although a preferred embodiment of the invention has been described in detail, such description is intended to be illustrative rather than limiting, for the invention may be variously embodied and is to be limited only by interpretation of the claims that follow.

I claim:

1. A neon tube support comprising:
a. a stem member that is made from a polymeric or similar material;
b. a neon tube support saddle and engaging clip that is made from said polymeric or similar material, and that incorporates at least one locking mechanism; and
c. a restraining element that is made from said polymeric or similar material, and incorporates at least one locking mechanism, which interlocks with said engaging clip's locking mechanism.

2. Said neon tube support of claim 1 wherein said stem member is made from an opaque material.

3. Said neon tube support of claim 1 wherein said stem member is made from a translucent material allowing light can pass through.

4. Said neon tube support of claim 1 wherein said neon tube support saddle and engaging clip are made from an opaque material.

5. Said neon tube support of claim 1 wherein said neon tube support saddle and engaging clip are made from a translucent material allowing light can pass through.

6. Said neon tube support of claim 1 wherein said restraining element is made from an opaque material.

7. Said neon tube support of claim 1 wherein said restraining element is made from a translucent material that allows light to pass through.

8. Said neon tube support of claim 1 wherein said engaging clip incorporates at least one female locking mechanism.

9. Said neon tube support of claim 1 wherein said restraining element incorporates at least one male locking mechanism.

10. Said neon tube support of claim 1 wherein said engaging clip incorporates at least one male locking mechanism.

11. Said neon tube support of claim 1 wherein said restraining element incorporates at least one female locking mechanism.

12. Said neon tube support of claim 1 wherein a locking mechanism is incorporated between said stem member and said neon tube support saddle.
